(19) United States
(12) Patent Application Publication
(10) Pub. No.: US 2005/0268560 A1
(43) Pub. Date: Dec. 8, 2005

(54) Assembling method for a vehicle door assembly

(75) Inventor: Suk-Hwan Kim, Suwon -City (KR)

Correspondence Address: MORGAN, LEWIS & BOCKIUS, LLP., 2 PALO ALTO SQUARE, 3000 EL CAMINO REAL, PALO ALTO, CA, 94306, US

(73) Assignee: Hyundai Motor Company

(21) Appl. No.: 10/306,507

(22) Filed: Nov. 27, 2002

Related U.S. Application Data
(62) Division of application No. 09/815,775, filed on Mar. 22, 2001, now abandoned.

(51) Int. Cl. E06B 3/00

(52) U.S. Cl. 49/506

(57) ABSTRACT

A door assembly for a vehicle adapted to simplify a door assembly process thereby improving door assembly manufacturing efficiency. The door assembly comprises a door trim assembly mounted with a window regulator assembly necessary for lifting a door window glass, a door lock assembly for opening and closing a door, and a door panel assembly coupled to the door trim assembly.

### RELATED APPLICATION

This application is a divisional of application Ser. No. 09/815,775, filed Mar. 22, 2001.

### BACKGROUND OF THE INVENTION

1. Field of the Invention

The present invention relates to a door assembly, and more particularly, a door assembly for a vehicle, adapted to simplify the assembly process of the vehicle thereby improving assembly efficiency.

2. Description of the Prior Art

In general, a vehicle is equipped with openable and closeable doors for passengers to get in and out, and open/close apparatus are installed thereto to open and close the doors.

As illustrated in FIG. 2, a door assembly for a vehicle comprises a door panel assembly 52 assembled by inner and outer panels 50 and 51; a window regulator assembly (comprising a window regulator (R) and a glass run channel (G)), a door lock assembly (comprising a door latch (L) and a door lock actuator (LA)), a door speaker (S) and door wiring (W) installed inside the door panel assembly 52; and a door trim 53 attached to the inner panel 50 to form the interior of the vehicle.

Now, an assembled state of the door will be described.

First, the door panel assembly 52 is formed by welding the inner/outer panels 50 and 51 together and the door panel assembly 52 is coupled to a plurality of parts for lifting the door window glass and opening and closing the door.

When the door panel assembly 52 is mounted with the plurality of parts, the door trim 53 is coupled to the door inner panel 50 to complete the door.

However, there is a problem in the door assembly process thus described in that the door panel assembly is assembled to attach parts for operating the door window glass and the like and then the door trim is attached to the inner panel. The process for mounting the parts to the door panel assembly becomes complicated due to the large number of parts.

In other words, the process of mounting a door wiring, a door latch, an inner handle, an inner handle rod, a window regulator, a door speaker and the like to the door panel assembly gets too complicated and thereby decreases door assembly efficiency.

### SUMMARY OF THE INVENTION

The present invention is disclosed to solve the aforementioned problem, and it is an object of the present invention to provide a door assembly for a vehicle, adapted to simplify a door assembly process thereby improving door assembly efficiency.

In accordance with the object of the present invention, there is provided a door assembly for a vehicle, the assembly comprising: a door trim assembly mounted with a window regulator assembly necessary for lifting a door window glass and a door lock assembly for opening and closing a door; and a door panel assembly coupled to the door trim assembly.

There is provided a method for assembling a door assembly, the method comprising the steps of: preparing a door trim; assembling a door trim assembly by mounting a window regulator assembly necessary for lifting a door window glass and a door lock assembly for opening and closing a door to the door trim; assembling a door panel assembly; and coupling the door trim assembly to the door panel assembly.

### BRIEF DESCRIPTION OF THE DRAWINGS

To fully understand the nature and objects of the invention, reference should be made to the following detailed description taken in conjunction with the accompanying drawings in which:

FIG. 1 is a schematic perspective view that illustrates a door assembly for a vehicle according to the present invention; and

FIG. 2 is a schematic perspective view that illustrates a door assembly for a vehicle according to the prior art.

### DETAILED DESCRIPTION OF THE INVENTION

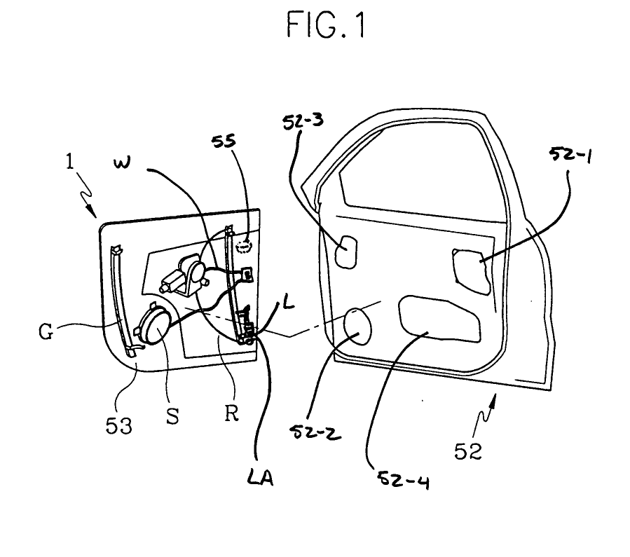

FIG. 1 is a schematic perspective view that illustrates a door assembly for a vehicle according to the present invention, where a door assembly is completed when a door panel assembly 52 is mounted to a door trim assembly 1. More particularly, a door trim 53, preassembled with door wiring (W), a door speaker (S), a window regulator assembly (comprising a window regulator (R) and a glass run channel (G)), and a door lock assembly (comprising a door latch (L) and a door lock actuator (LA)), is mounted to the inner panel of the door panel assembly 52.

In other words, a plurality of the above parts are assembled to the door trim 53 for modularization to make the door trim assembly 1, and the door assembly is completed when the door trim assembly 1 is fixed to the door panel assembly 52.

The door panel assembly 52 is constructed to allow the door trim 53, containing the above parts, to be easily inserted and form an integrated unit without any interference.

In other words, the inner panel of the door panel assembly 52 comprises a first hole 52-1 for accommodating the window regulator R, a second hole 52-2 for accommodating a door latch L, a third hole 52-3 for accommodating an inside door handle 55, and a fourth hole 52-5 for accommodating a speaker S, for smooth insertion so as to prevent interference with the parts.

Now, the operational effect of the present invention thus constructed will be described.

First, a plurality of the parts (parts for lifting the door glass window and parts for opening and closing the door), for example, the regulator (R), door wiring (W), door latch (L), and an inner handle, are assembled onto the door trim 53 to finish assembly of the door trim assembly 1. The door panel assembly 52 is also independently assembled.

Once the door trim assembly 1 and the door panel assembly 52 are individually assembled, the door trim assembly 1 is then mounted to the door panel assembly 52 to complete the door assembly.

In other words, the door trim assembly 1 is assembled in one process while the door panel assembly 52 is assembled in another process. The two assemblies are thereafter attached, simplifying the assembly process in the final assembly line.

Thus, the process of preassembling the modular door trim assembly 1 and door panel assembly 52, in effect, minimizes the storage space required to complete assembly of the vehicle door in the main assembly line.

Furthermore, the plurality of parts are fixed to the door trim 53 as the latter moves down the main assembly line, greatly reducing logistics costs in comparison to a method where the plurality of parts are kept in individual states.

Particularly, the modular door trim assembly 1 and door panel assembly 52 are formed into one integrated unit, thereby improving assembly efficiency to a great extent.

As apparent from the foregoing, the present invention provides an advantage in the manufacture of a door assembly for a vehicle in that a door trim is preassembled with parts such as door wiring and a door window regulator, which is then coupled to a door panel assembly to complete the door assembly, such that door assembly manufacturing efficiency is enhanced and logistics costs are also reduced.

1-2. (canceled)

3. A method for assembling a door assembly, comprising:
preparing a door trim;
mounting a window regulator assembly, for lifting a door window glass, and a door lock assembly, for opening and closing a door, to the door trim to form a preassembled door trim assembly;
assembling together an inner panel and an outer panel to form a door panel assembly; and
coupling the preassembled door trim assembly to the inner panel of the door panel assembly.

4. The method as defined in claim 3, wherein the door panel assembly comprises an inner panel and an outer panel coupled to the inner panel.

5. The method for assembling a door assembly of claim 4, wherein assembling a door trim assembly further includes mounting door wiring and a door speaker to the door trim.
